(19) United States
(12) Patent Application Publication
(10) Pub. No.: US 2010/0195742 A1
(43) Pub. Date: Aug. 5, 2010

(54) ERROR CONCEALMENT METHOD AND APPARATUS

(75) Inventor: Chung-Bin Wu, Kaohsiung City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: MEDIATEK INC., Hsin-Chu (TW)

(21) Appl. No.: 12/363,811

(22) Filed: Feb. 2, 2009

(51) Int. Cl. H04N 7/26

(52) U.S. Cl. 375/240.27; 375/E07.027; 375/E07.208

(57) ABSTRACT

An embodiment of error concealment method for a bitstream is provided. The method first detects an error in a current frame of the bitstream, and when the error is detected, an error concealment procedure is performed on the current frame, starting from a first macroblock thereof preceding a second macroblock associated with the detected error.

### BACKGROUND OF THE INVENTION

1. Field of the Invention

The invention relates to video decoding, and more particularly to an error concealment method and apparatus for decoded compressed video.

2. Description of the Related Art

With the development of electronic devices such as televisions and computers, static and/or moving images may be displayed on a display device. Generally, the images are electronic video data that may be stored, duplicated, transmitted, manipulated, processed, compressed, and/or deleted. As such, the image data may be lost or corrupt, causing an error, such as an error segment, to appear in the displayed frame. The image error is a noticeable distraction for viewers and can vary in its size and shape. Furthermore, for future frames of moving images which are dependent upon the frame that contains the error, the negative effects of the error are compounded. Specifically, the error is an even more noticeable distraction for viewers.

### BRIEF SUMMARY OF THE INVENTION

An embodiment of error concealment method for a bitstream is provided. The method first detects an error in a current frame of the bitstream, and when the error is detected, an error concealment procedure is performed on the current frame, starting from a first macroblock thereof preceding a second macroblock associated with the detected error.

Another embodiment of the invention provides a video processing apparatus comprising a frame buffer, a video decoder, a mode decision unit and an error concealment unit. The video decoder receives and decodes a bitstream to generate decoded data, and detects an error in a current frame of the decoded data. The mode decision unit receives information of detected error from the video decoder and determines a mode of an error concealment procedure according to the received information of the detected error. The error concealment unit receives the decoded data and performs the error concealment procedure on the decoded data according to the determined mode to generate and forward error-corrected video data to the frame buffer.

Another embodiment of the invention provides an error concealment method for a bitstream, comprising detecting an error in a current frame of the bitstream; detecting position of a macroblock associated with the detected error; detecting position of a first normal macroblock following the detected error; determining a start position and an end position of macroblocks in the current frame for performing an error concealment procedure according to the detected position of the macroblock associated with the detected error and the detected position of the first normal macroblock following the detected error; performing the error concealment procedure on the current frame in accordance with the determined start position and end position.

A detailed description is given in the preceding embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a block diagram of a video processing apparatus with error concealment according to an embodiment of the invention.

FIG. 2 is a schematic diagram showing the error in a current frame.

FIG. 3 is a block diagram of an embodiment of a video processing apparatus with error concealment according to the invention.

FIG. 4 is a block diagram of another embodiment of a video processing apparatus with error concealment according to the invention.

FIG. 5 is a flowchart of an embodiment of an error concealment method of the invention.

FIG. 6 is a flowchart of another embodiment of an error concealment method of the invention.

FIGS. 7a and 7b show schematic diagrams of error concealment procedure when a motion vector error occurs.

### DETAILED DESCRIPTION OF THE INVENTION

The preceding description is of the best-contemplated mode of carrying out the invention. This description is made for the purpose of illustrating the general principles of the invention and should not be taken in a limiting sense. The scope of the invention is best determined by reference to the appended claims.

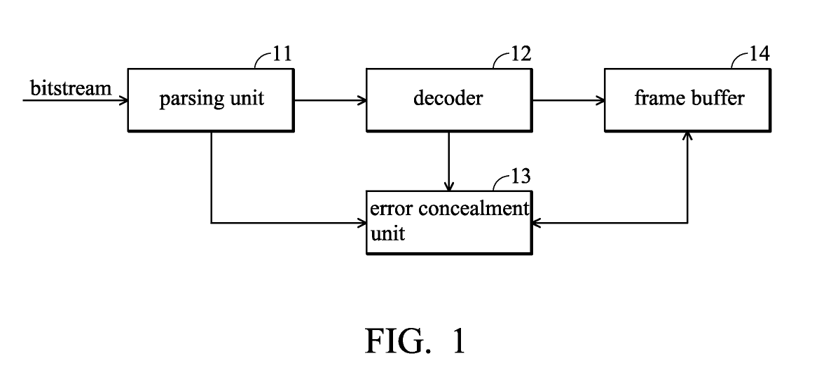

FIG. 1 is a block diagram of a video processing apparatus with error concealment according to an embodiment of the invention. A parsing unit 11 receives and parses a bitstream to generate parsed data. The parsing unit 11 further detects the bitstream to determine whether an error is occurred in the data of the bitstream. When an error is detected, the parsing unit 11 transmits the information of the detected error and parsed video data to the error concealment unit 13. The error concealment unit 13 may discard a current frame where the error is detected and generates a new frame based on at least one reference frame from the frame buffer 14. In one embodiment, the error concealment unit 13 substitutes a preceding frame for the current frame.

If no error is detected by the parsing unit 11, the parsed video data is transmitted to a decoder 12. When the decoder 12 normally decodes video data from the parsing unit 11, the decoded video data is then transmitted and stored in the frame buffer 14. Similarly, the decoder 12 may detects whether a current frame of the video data contains an error. If yes, video data together with information of the detected error is transmitted to the error concealment unit 13. If the parsing unit 11 or decoder 12 detects an error, the error concealment unit 13 applies an error concealment procedure to the damaged video data to generate new video data, and the new video data is then transmitted to the frame buffer 14.

Typically, the error concealment procedure is performed only on the macroblock (MB) A associated with the detected error or macroblocks after the macroblock A. That is conventional error concealment procedure is performed only on macroblocks on or after the first MB where the error is detected. However, the error concealment procedure of this embodiment is performed on a macroblock B preceding the macroblock A associated with the detected error. In another embodiment, the macroblock B may be the macroblock next to the macroblock A, or there are several macroblocks between the macroblock B and the macroblock A.

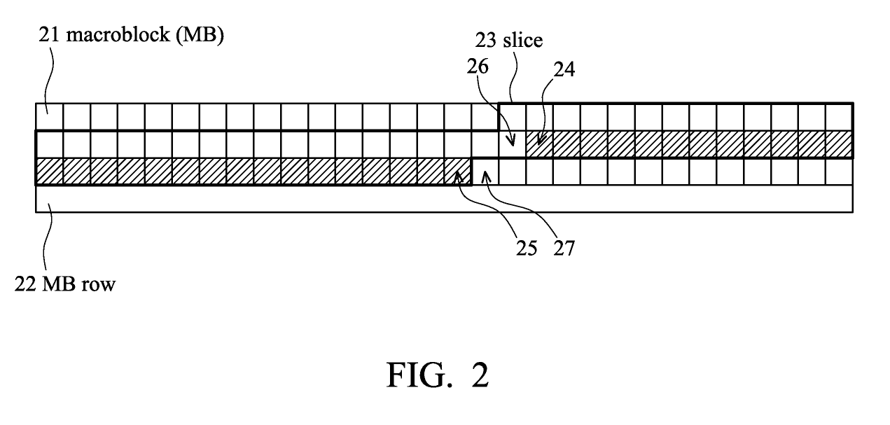

FIG. 2 is a schematic diagram of an embodiment of the composition of a current frame. The numeral 21 indicates a macroblock (MB) which is the basic unit of the frame. The numeral 22 indicates a MB row comprising a plurality of macroblocks, wherein the number of the macroblocks which the MB row has is determined based on the video standard or the video transmission standard. The numeral 23 indicates a slice having a plurality of macroblocks, wherein the size of one slice is determined based on the video standard or the video transmission standard. The numeral 24 indicates the first macroblock where the error has been detected, the numeral 25 indicates the end of the error, and the numeral 27 indicates the first normal macroblock behind the error. In FIG. 2, the defective macroblocks represented by shadow lattices are in the slice 23. Typically, the defective macroblocks will be processed by an error concealment procedure, and the error concealment procedure replaces the defective macroblocks with normal macroblocks in the corresponding position of a first frame, such as a previous frame or a reference frame. The error is detected in the macroblock 24; however, the video data before the macroblock 24 may not conform to viewer expectations. Therefore, in an embodiment of the invention, the error concealment procedure is applied on the macroblocks preceding the macroblock 24. More specifically, the error concealment procedure is applied on the macroblock preceding the macroblock 24, such as the macroblock 26, and usually the macroblocks between the macroblocks 26 and 25, including the MB 24, are replaced with other video data such as corresponding macroblocks of a previous frame or a reference frame. In one embodiment, the error concealment procedure can also be applied on a MB, a MB row, or a slice basis according to the detected error types.

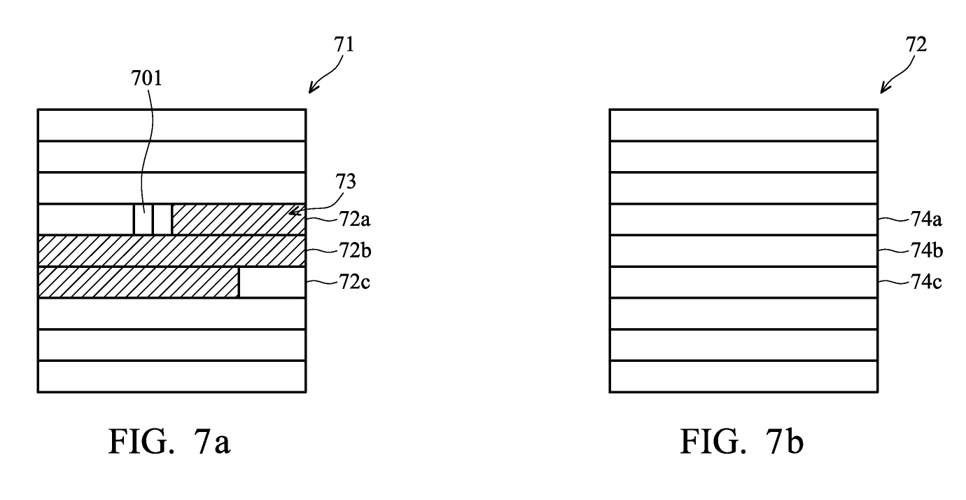

For example, if the detected error is a DCT (discrete cosine transform, DCT) coefficients error which is generally occurred in macroblocks near the macroblock 24, the error concealment procedure is performed on a MB basis; that is it is applied in a per macroblock fashion. More specifically, the error concealment procedure is performed on the macroblocks between a predetermined macroblock preceding the macroblock 24, and the macroblock 27, wherein the predetermined macroblock may be the macroblock next to the macroblock 24, such as the macroblock 26, or the macroblock several macroblocks ahead of the macroblock 24. In another embodiment, the error concealment procedure is performed on all the macroblocks from or after the predetermined macroblock preceding the macroblock 24. If the error is a motion vector error, the error concealment procedure is performed on a MB row basis; that is the macroblock row associated with the predetermined macroblock is replaced with corresponding macroblock rows in the first frame. Alternatively, the macroblock rows associated with the predetermined macroblock, macroblock 24 and the macroblock 25 are replaced with corresponding macroblock rows in the first frame. Please refer to FIGS. 7a and 7b. FIGS. 7a and 7b show schematic diagrams of error concealment procedure when a motion vector error occurs. In FIG. 7, the error 73 occurs in the macroblock rows 72a, 72b and 72c of the current frame 71, wherein the macroblock 701 is the predetermined macroblock preceding the first macroblock of the error 703. The error concealment procedure selects the corresponding macroblock row associated with the predetermined macroblock 701 in the previous frame 72, MB rows 74a, and replaces the defective MB rows 72a with the MB rows 74a. Alternatively, the error concealment procedure selects the corresponding macroblock rows in the previous frame 72, MB rows 74a, 74b and 74c, and replaces the defective MB rows 72a, 72b and 72c with the MB rows 74a, 74b and 74c. It is noted that the error concealment procedure only illustrates with the previous frame, not to limit the invention thereto.

Furthermore, if the error is a context-based adaptive binary arithmetic coding (CABAC) error, the error concealment procedure is performed on a slice basis; that is the slices associated with the predetermined macroblock may be replaced by corresponding slices in the first frame. Alternatively, the slices associated with the predetermined macroblock, the macroblocks 24 and 25 may be replaced by corresponding slices in the first frame. As shown, the slice 23 is replaced by a corresponding slice in the first frame.

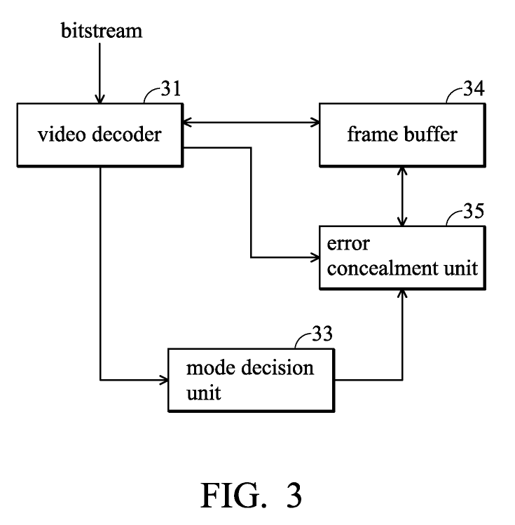

FIG. 3 is a block diagram of a video processing apparatus with error concealment for a bitstream according to another embodiment of the invention. The video decoder 31 receives and decodes the bitstream to generate decoded data. The video decoder 31 further detects whether a current frame of the decoded data has an error. If yes, the video decoder 31 transmits the current frame of the decoded data and information of the detected error, such as the error type thereof, to the error concealment unit 35 and the mode decision unit 33 respectively. If not, the current frame of the decoded data is directly transmitted to the frame buffer 34. When the mode decision unit 32 receives the information of the detected error, the mode decision unit 32 determines a mode of an error concealment procedure according to the information of the detected error. In an embodiment of the invention, the information of the detected error comprises a type of the detected error. In this case, the mode decision unit 32 determines the mode of the error concealment procedure according to the type of the detected error. The type of the detected error may be a DCT (discrete cosine transform, DCT) coefficients error, a CABAC error, a motion vector error or the likes. The mode of the error concealment procedure comprises MB, MB row, and slice modes. After determining the mode, the mode decision unit 32 transmits the determination result to the error concealment unit 35 for executing a corresponding error concealment procedure on the decoded video data therewith. The error concealment unit 35 accordingly generates and forwards error-corrected video data to the frame buffer 34. The operations of performing the error concealment procedure are similar to those described previously. More specifically, the error concealment unit 35 performs the error concealment procedure on the current frame, starting from a first macroblock preceding a second macroblock associated with the detected error. In an embodiment of the invention, the error concealment unit 35 replaces macroblocks in the current frame, starting from the first macroblock with corresponding macroblocks in a first frame, wherein the first frame is a previous frame of the current frame or a reference frame of the current frame. When the mode decision unit 32 determines the mode of the error concealment procedure to be the MB mode, the error concealment unit 35 performs the error concealment procedure in a MB basis. When the mode decision unit 32 determines the mode of the error concealment procedure to be the MB row mode, the error concealment unit 35 replaces macroblock row associated with the first and second macroblocks with corresponding macroblock row in the first frame. Similarly, when the mode decision unit 32 determines the mode of the error concealment procedure to be the slice mode, the error concealment unit 35 replaces slice associated with the first and second macroblocks with corresponding slice in the first frame.

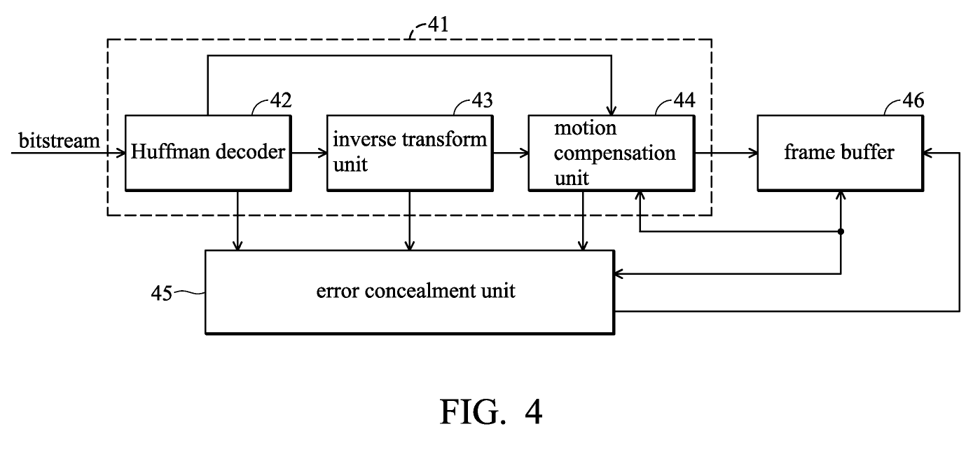

FIG. 4 is a block diagram of a video processing apparatus with error concealment for a bitstream according to another embodiment of the invention. The video decoder 41 comprises a Huffman decoder 42, an inverse transform unit 43 and a motion compensation unit 44. The bitstream is sequentially transmitted and processed by the Huffman decoder 42, the inverse transform unit 43 and the motion compensation unit 44. In FIG. 4, it is noted that the data from the Huffman decoder 42 can be directly transmitted to the motion compensation unit 44. The motion compensation unit 44 retrieves a reference frame from the frame buffer 46 for processing the received image data. Once an error is detected by the Huffman decoder 42, the inverse transform unit 43 or the motion compensation unit 44, the data is then transmitted to the error concealment unit 45 for concealing the error. The error concealment unit 45 receives a first frame from the frame buffer 46, such as a corresponding reference frame or a previous frame, and conceals the error based on the first frame. Furthermore, in another embodiment, the error concealment unit 45 can execute different error concealment procedures based on the error type.

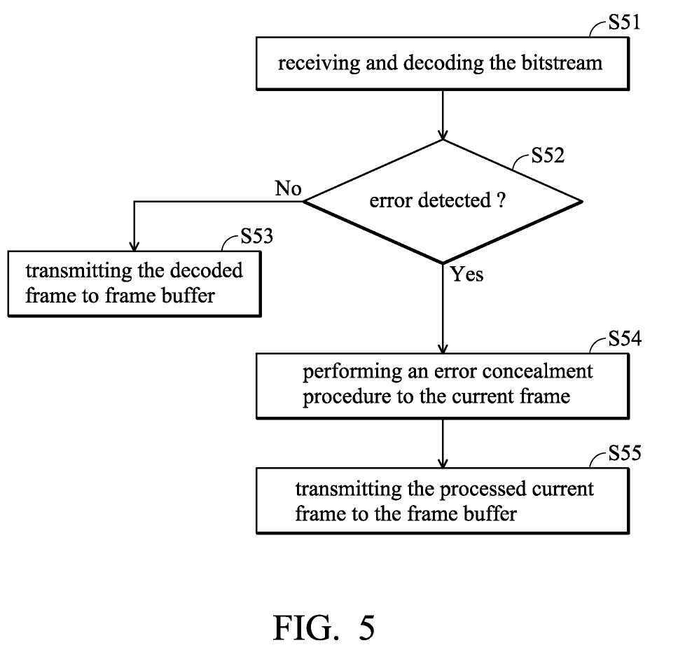

FIG. 5 is a flowchart of an embodiment of an error concealment method of the invention. In step S51, a video decoder receives and decodes the bitstream. The method proceeds to step S52 where it is determined whether an error is detected in the bitstream. When the error is detected in a current frame of the bitstream in step S52, the method goes to step S54 where an error concealment procedure is performed on the current frame. If no error is detected in the current frame in step S52, the method jumps to step S53 where the decoded frame is transmitted to a frame buffer. As previously described, when performing the error concealment procedure in step S54, it is performed on macroblocks of the current frame, starting from a first macroblock preceding a second macroblock associated with the detected error, such as the macroblock in which the error is first detected. In another embodiment, the first macroblock may be the macroblock next to the second macroblock or there are several macroblocks between the first and second macroblocks. Step S55 follows step S54, in which the processed current frame is transmitted to the frame buffer.

In addition, the error concealment procedure in step S54 may be performed on MB, MB row, or slice basis according to the type of the detected error. For example, when the error is a DCT (discrete cosine transform, DCT) coefficients error, the error concealment procedure may be performed on the first macroblock preceding the second macroblock associated with the detected error on the MB basis. If the error is a motion vector error, the macroblock rows associated with the first macroblock and the second macroblock are replaced by macroblock rows in a first frame, wherein the macroblock rows of the first frame for replacement are in the corresponding position as the substituted macroblock rows in the current frame. The first frame may be a previous frame of the current frame or a reference frame of the current frame. Furthermore, if the error is a CABAC error, the slice associated with the first and second macroblocks is replaced by corresponding slice in the first frame, wherein the slice of the first frame for replacement is in the corresponding position as the substituted slice in the current frame. Similarly, the first frame may be a previous frame or a reference frame of the current frame.

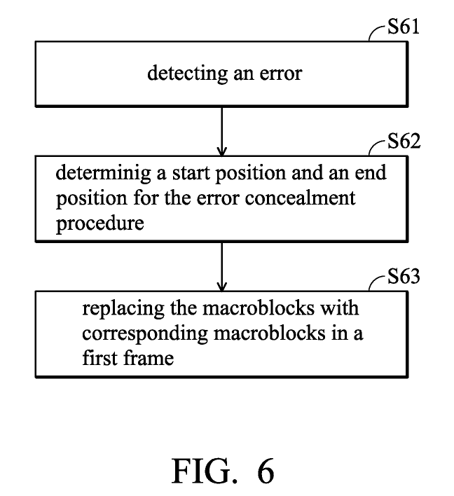

FIG. 6 is a flowchart of an error concealment method for a bitstream according to another embodiment of the invention. In step S61, a detection unit is applied to detect whether an error has occurred in a current frame of the bitstream and to detect the position of the macroblock associated with the error in the current frame. After the detection of the error, the detection unit detects the position of the first normal macroblock following the macroblock associated with the error. In step S62, an image processing unit determines the start position and the end position of the macroblocks in the current frame for the error concealment procedure to be performed according to the detected positions of the macroblock associated with the error and the first normal macroblock. In step S63, the macroblocks from the start position to the end position in the current frame are replaced with corresponding macroblocks in a first frame, wherein the first frame is a previous frame or a reference frame of the current frame.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An error concealment method for a bitstream, comprising:
detecting an error in a current frame of the bitstream; and
when the error is detected, an error concealment procedure is performed on the current frame, starting from a first macroblock thereof preceding a second macroblock associated with the detected error.

2. The method as claimed in claim 1, wherein the detected error is a discrete cosine transform (DCT) coefficients error, a context-based adaptive binary arithmetic coding (CABAC) error or a motion vector error.

3. The method as claimed in claim 1, wherein the error concealment procedure comprises:
receiving a first frame; and
replacing macroblocks in the current frame, starting from the first macroblock with corresponding macroblocks in the first frame.

4. The method as claimed in claim 3, wherein the first frame is a previous frame of the current frame.

5. The method as claimed in claim 3, wherein the first frame is a reference frame of the current frame.

6. The method as claimed in claim 1, wherein the error concealment procedure is performed according to a type of the detected error.

7. The method as claimed in claim 1, wherein the error concealment procedure is performed on a macroblock(MB) basis, a MB row basis, or a slice basis according to a type of the detected error.

8. The method as claimed in claim 7, wherein when the error concealment procedure is performed on the MB row basis, the error concealment procedure comprises:
receiving a first frame; and
replacing macroblock row associated with the first macroblock and the second macroblock with corresponding macroblock row in the first frame.

9. The method as claimed in claim 8, wherein the error is a motion vector error.

10. The method as claimed in claim 7, wherein when the error concealment procedure is performed on the slice basis, the error concealment procedure comprises:
receiving a first frame; and
replacing slice associated with the first macroblock and the second macroblock with corresponding slice in the first frame.

11. The method as claimed in claim 10, wherein the error is a CABAC error.

12. A video processing apparatus, comprising:
a frame buffer;
a video decoder receiving and decoding a bitstream to generate decoded data, and detecting an error in a current frame of the decoded data;
a mode decision unit receiving information of detected error from the video decoder and determining a mode of an error concealment procedure according to the received information of the detected error; and
an error concealment unit receiving the decoded data and performing the error concealment procedure on the decoded data according to the determined mode to generate and forward error-corrected video data to the frame buffer.

13. The apparatus as claimed in claim 12, wherein the error concealment unit performs the error concealment procedure on the current frame, starting from a first macroblock preceding a second macroblock associated with the detected error.

14. The apparatus as claimed in claim 13, wherein the error concealment unit replaces macroblocks in the current frame, starting from the first macroblock with corresponding macroblocks in a first frame.

15. The apparatus as claimed in claim 14, wherein the first frame is a previous frame of the current frame or a reference frame of the current frame.

16. The apparatus as claimed in claim 12, wherein the mode of the error concealment procedure comprises macroblock (MB), MB row, and slice modes.

17. The apparatus as claimed in claim 16, wherein when the mode of the error concealment procedure is determined to be the MB row mode, the error concealment unit replaces macroblock row associated with the first and second macroblocks with corresponding macroblock row in a first frame.

18. The apparatus as claimed in claim 16, wherein when the mode of the error concealment procedure is determined to be the slice mode, the error concealment unit replaces slice associated with the first and second macroblocks with corresponding slice in a first frame.

19. An error concealment method for a bitstream, comprising:
detecting an error in a current frame of the bitstream;
detecting position of a macroblock associated with the detected error;
detecting position of a first normal macroblock following the detected error;
determining a start position and an end position of macroblocks in the current frame for performing an error concealment procedure according to the detected position of the macroblock associated with the detected error and the detected position of the first normal macroblock following the detected error; and
performing the error concealment procedure on the current frame in accordance with the determined start position and end position.

20. The method as claimed in claim 19, wherein performing the error concealment procedure comprises replacing macroblocks from the start position to the end position in the current frame with corresponding macroblocks in a first frame.

21. The method as claimed in claim 20, wherein the first frame is a previous frame of the current frame or a reference frame of the current frame.
